(19) United States
(12) Patent Application Publication
(10) Pub. No.: US 2004/0152419 A1
(43) Pub. Date: Aug. 5, 2004

(54) Method for displaying reception sensitivity on a multi-functional mobile terminal

(75) Inventor: Bo-Nam Lee, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/748,901

(22) Filed: Dec. 30, 2003

(30) Foreign Application Priority Data
Jan. 3, 2003 (KR) 2003/00360

(51) Int. Cl. H04B 17/00

(52) U.S. Cl. 455/67.7; 455/566; 455/12.1; 455/427

(57) ABSTRACT

A method for displaying reception sensitivity on a multi-functional mobile terminal providing a user with signal reception states of a variety of communication functions incorporated with the multi-functional mobile terminal by checking a reception sensitivity of a reception signal for a prescribed communication function among a plurality of communication functions, and displaying a reception sensitivity indicator for indicating the checked reception sensitivity on the display screen. If an operation mode of a communication function other than the prescribed communication function is enabled, checking reception sensitivity of a reception signal for a communication function of the enabled operation mode, and displaying a reception sensitivity indicator for indicating the checked reception sensitivity on the display screen.

### PRIORITY

This application claims priority to an application entitled “METHOD FOR DISPLAYING RECEPTION SENSITIVITY ON MULTI-FUNCTIONAL MOBILE TERMINAL”, filed in the Korean Intellectual Property Office on Jan. 3, 2003 and assigned Serial No. 2003-00360, the contents of which are hereby incorporated by reference.

### BACKGROUND OF THE INVENTION

1. Field of the Invention

The present invention relates generally to a mobile terminal, and more particularly to a method for displaying reception sensitivity on a display screen of a multi-functional mobile terminal with a variety of communication functions.

2. Description of the Related Art

Typically, a mobile terminal displays a variety of information such as operation and reception information, etc., on its own display screen such as an LCD (Liquid Crystal Display) panel, enabling a user to view such information on the mobile terminal. Particularly, some aspects of the above various information, for example, reception sensitivity, alarm setting, an SMS (Short Message Service) message, an E-mail reception message, a battery lifetime, etc., is displayed on the mobile terminal using dedicated indicators. The indicator for the reception sensitivity indicates an RSSI (Received Signal Strength Indicator) level of a reception signal from a mobile telecommunication network. A user of such a mobile terminal can recognize a signal reception status from the mobile telecommunication network simply by viewing the reception sensitivity indicator, such that the user determines on the basis of the recognized signal reception status whether phone service is available or not. Also, although it is determined that the phone service is available, the user is able to predict a QoS level of the phone service on the basis of signal reception sensitivity.

Recently, multi-functional mobile terminals have been proposed, which provide a variety of additional functions in addition to a unique mobile communication function. Representative functions of the additional functions of the multi-functional mobile terminals include, for example, a GPS (Global Positioning System) reception function, and a Bluetooth communication function. A multi-functional mobile terminal having such a GPS reception function includes a GPS module for receiving GPS signals from a plurality of GPS satellites, and recognizes its current position on the basis of GPS position information accompanied with the GPS signals. Likewise, the multi-functional mobile terminal can provide a user with a navigation service on the basis of the current position information. Other multi-function mobile terminals having the Bluetooth communication function include a Bluetooth module for the Bluetooth communication function, thereby establishing a Bluetooth communication with other peripheral devices supporting the Bluetooth communication function.

Such a multi-functional mobile terminal having one or more two communication functions, in addition to the above general mobile communication functions needs to ensure a good signal reception status for each communication function in order to provide a user with other communication functions as well as general mobile communication functions. However, the conventional multi-functional mobile terminal does not display a reception status of other communication functions other than the general mobile communication function on its own display panel, whereas it displays a reception sensitivity indicator for the general mobile communication function on the same. Therefore, when a user of the multi-functional mobile terminal desires to use the arbitrary communication function other than general mobile communication functions, the user selects an operation mode for executing the arbitrary communication function even though the necessary information for indicating whether the arbitrary communication function is available or not is unknown. In this case, if the user attempts to execute a desired communication function even though the multi-functional mobile terminal is located in a non-communication area, wherein the arbitrary communication function is disabled, unnecessary loss of time and a user's inconvenience may be unavoidably caused. Particularly, provided that the user wants to receive a navigation service using the GPS reception function on the multi-functional mobile terminal, the user must not only receive GPS signals from GPS satellites, but also gain access to a navigation service system over a mobile telecommunication network. So, although GPS signals are transmitted to the multi-functional mobile terminal and the multi-functional mobile terminal does not find the GPS satellites for providing a user with current terminal position information, unnecessary charges may be assessed to the user.

Consequently, because a user cannot recognize a signal reception status of other communication functions other than a general mobile communication function in a multi-functional mobile terminal with a variety of communication functions, the user attempts to activate a desired communication function in even a non-communication area, resulting in unnecessary loss of time as well as unnecessary charges to the user.

### SUMMARY OF THE INVENTION

Therefore, the present invention has been designed in view of the above and other problems, and it is an object of the present invention to provide a method for displaying reception sensitivity on a multi-functional mobile terminal to provide a user with signal reception states of a variety of communication functions incorporated with the multi-functional mobile terminal.

It is another object of the present invention to provide a method for displaying reception sensitivities of a variety of communication functions incorporated with a multi-functional mobile terminal to make it possible for a user to recognize the reception sensitivities.

In accordance with one aspect of the present invention, the above and other objects are accomplished by a method for displaying reception sensitivity on a display screen of a multi-functional mobile terminal with at least two communication functions, including the steps of a) checking a reception sensitivity of a reception signal for a prescribed communication function among the communication functions, and displaying a reception sensitivity indicator for indicating the reception sensitivity of the prescribed communication function on the display screen; and b) if an operation mode of a communication function other than the prescribed communication function is enabled, checking a reception sensitivity of a reception signal for the communication function corresponding to the enabled operation mode, and displaying a reception sensitivity indicator for indicating the reception sensitivity of the communication function corresponding to the enabled operation mode on the display screen.

In accordance with another aspect of the present invention, there is provided a method for displaying reception sensitivity on a display screen of a multi-functional mobile terminal with at least two communication functions, including the steps of: a) checking a reception sensitivity of a reception signal for a prescribed communication function among the communication functions, and displaying a reception sensitivity indicator for indicating the reception sensitivity of the prescribed communication function on the display screen; and b) upon receiving a user request to change the reception sensitivity indicator, checking a reception sensitivity of a reception signal for a communication function other than the prescribed communication function among the communication functions, and displaying a reception sensitivity indicator for indicating the reception sensitivity of the other communication function on the display screen.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a multi-functional mobile terminal according to the present invention;

FIGS. 2A˜2C illustrate exemplary screens on which reception sensitivity indicators are displayed;

FIG. 3 is a flow chart illustrating a procedure for indicating reception sensitivity for use in an operation mode selected by a user according to a preferred embodiment of the present invention; and

FIG. 4 is a flow chart illustrating a procedure for indicating reception sensitivity when a user wants to change a reception sensitivity indicator according to another preferred embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

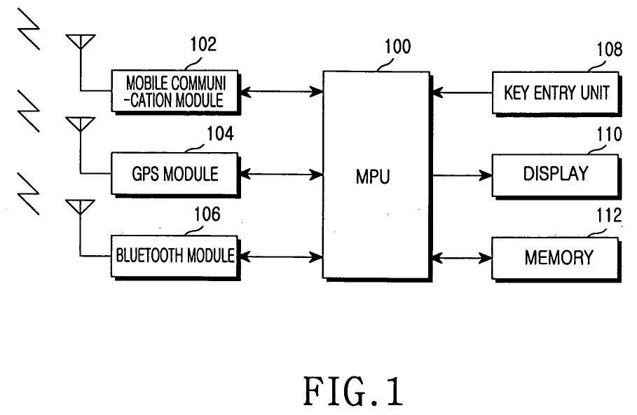

FIG. 1 is a block diagram of a multi-functional mobile terminal with a GPS reception function and a Bluetooth communication function in addition to a unique mobile communication function according to the present invention. Referring to FIG. 1, the multi-functional mobile terminal includes a mobile communication module 102 for executing a mobile communication function over a mobile telecommunication network, a GPS module 104 for receiving a GPS signal from a GPS satellite, and a Bluetooth module 106 for establishing Bluetooth communication with peripheral devices having other Bluetooth communication functions. An MPU (Micro-Processor Unit) 100 controls a mobile communication function of the mobile communication module 102, a GPS reception function of the GPS module 104, and a Bluetooth communication function of the Bluetooth module 106. A key entry unit 108 includes a plurality of number keys and a variety of function keys, and transmits a key entry signal received by a user's key stroke to the MPU 100. A display 110 is a display module such as an LCD (Liquid Crystal Display) panel, and displays information indicating operation states controlled by the MPU 100 or a variety of data such as signal reception information thereon. A memory 112 stores programs for operating the MPU 100 and a variety of reference data therein, and has a working memory for temporarily storing a variety of data needed to activate the MPU 100.

The aforementioned multi-functional mobile terminal is activated in a basic mobile communication mode when a GPS mode or a Bluetooth mode is not selected. The GPS mode is an operation mode for executing the GPS reception function at the GPS module 104, and the Bluetooth mode is an operation mode for executing the Bluetooth communication function at the Bluetooth module 106. These GPS and Bluetooth modes are enabled by a user's menu selection signal or a specific function key stroke on the key entry unit 108. The MPU 100 activates the GPS module 104 or the Bluetooth module 106 according to such key entry signals to execute a corresponding operation mode.

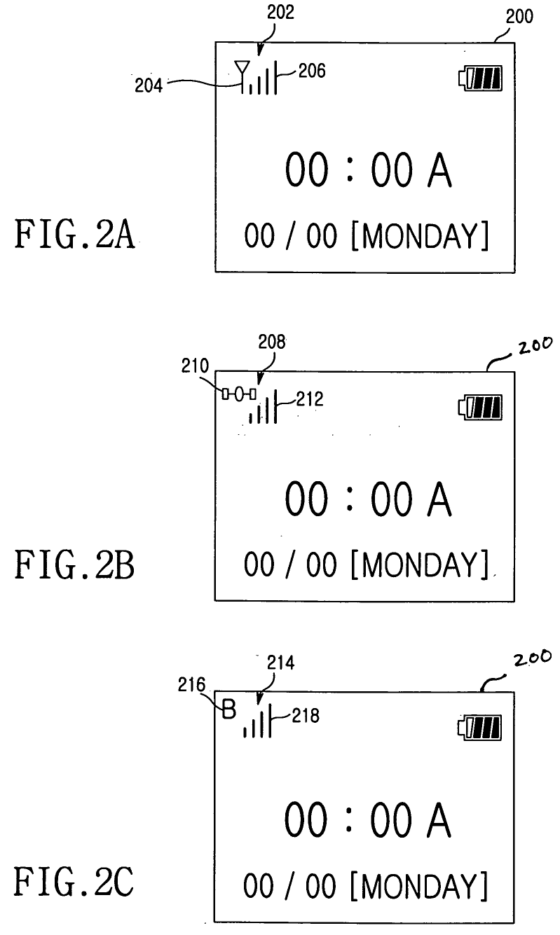

The MPU 100 displays a reception sensitivity indicator on a screen 200 of the display 110 of the multi-functional mobile terminal, as illustrated in FIGS. 2A˜2C. FIG. 2A illustrates an exemplary display screen 200 on which a mobile communication reception sensitivity indicator 202 is displayed. Referring to FIG. 2A, the mobile communication reception sensitivity indicator 202 is composed of an icon 204, which indicates that mobile communication reception sensitivity is being indicated, and another icon 206, which is a meter for indicating reception sensitivity. In the same manner as a typical mobile terminal, the reception sensitivity icon 206 corresponds to an RSSI level of a signal received at the mobile communication module 102 over an antenna from a mobile telecommunication network. Here, in the same manner as a method for displaying a reception sensitivity indicator on a conventional mobile terminal, the higher the RSSI level becomes, the more and longer the bars are displayed as the reception sensitivity icon 206.

FIG. 2B illustrates an exemplary display screen on which a GPS reception sensitivity indicator 208 is displayed. Referring to FIG. 2B, the GPS reception sensitivity indicator 208 is composed of an icon 210, which indicates that GPS reception sensitivity is being indicated, and another icon 212, which is a meter for indicating the GPS reception sensitivity. The reception sensitivity icon 212 corresponds to the number of GPS satellites found by a GPS signal received at the GPS module 104. In this case, the more GPS satellites are found on the GPS reception sensitivity indicator 208, the longer the bars become. Namely, the length of each bar is proportional to the number of GPS satellites.

FIG. 2C illustrates an exemplary display screen on which a Bluetooth reception sensitivity indicator 214 is displayed. Referring to FIG. 2C, the Bluetooth reception sensitivity indicator 214 is composed of an icon 216, which indicates that Bluetooth reception sensitivity is being indicated, and another icon 218, which is a meter for indicating the Bluetooth reception sensitivity. The reception sensitivity icon 218 corresponds to an RSSI level of a Bluetooth signal received at the Bluetooth module 106. In this case, the longer the bars become on the reception sensitivity icon 218, the higher the RSSI level is.

In accordance with the present invention, display of such a reception sensitivity indicator corresponding to each communication function on the display screen as illustrated in FIGS. 2A˜2C is executed when an operation mode of a corresponding communication function is enabled or a user wants to display a different reception indicator. In order to display mobile communication reception sensitivity, the GPS reception sensitivity, and the Bluetooth reception sensitivity on a display panel as illustrated in FIGS. 2A˜2C, the mobile communication module 102, the GPS module 104, and the Bluetooth module 106 should determine their own reception sensitivities, respectively. The mobile communication reception sensitivity information created by a mobile communication module 102 is produced by a conventional mobile terminal. The Bluetooth reception sensitivity information created by the Bluetooth module 106 is determined based on the RSSI level of a reception signal in the same manner as a mobile communication reception sensitivity. The GPS reception sensitivity information created by the GPS module 104 is determined on the basis of the number of GPS satellites found by a reception GPS signal. Conventionally, when the GPS module 104 receives GPS signals from 3 or more 3 GPS satellites, it is determined that a GPS tracking service is completed. Therefore, the number of GPS satellites found by the GPS signal received at the GPS module 104 is checked as reception sensitivity. In this manner, the number of GPS satellites is commonly checked by the GPS module 104 such that a detailed description thereof will hereinafter be omitted.

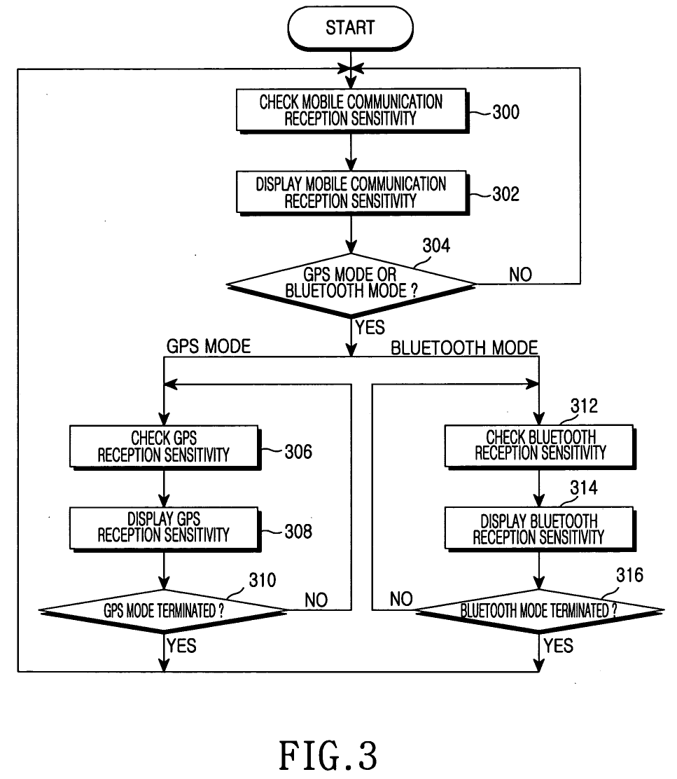

FIG. 3 is a flow chart illustrating a procedure for indicating reception sensitivity for use in an operation mode selected by a user according to a preferred embodiment of the present invention. FIG. 3 denotes a plurality of steps 300˜316 serving as processes of the MPU 100. With reference to FIG. 3, the MPU 100 checks reception sensitivity of a signal received from a mobile telecommunication network using the mobile communication module 102 at step 300, displays the mobile communication reception sensitivity indicator 202 for displaying a mobile communication reception sensitivity on a display screen 200 of the display 110 at step 302 as illustrated in FIG. 2A, and determines whether GPS mode or Bluetooth mode is enabled or not at step 304. In other words, if a multi-functional mobile terminal is not enabled with the GPS mode or Bluetooth mode, a mobile communication reception sensitivity indicator is displayed on the display screen 200.

As stated above, when a user selects GPS mode or Bluetooth mode using a key entry unit 108 at step 304 while the mobile communication reception sensitivity indicator 202 is displayed on the screen 200, the MPU 100 executes either steps 306˜310 or steps 312˜316.

If the GPS mode is enabled by a user, the MPU 100 checks reception sensitivity of a GPS signal determined by the GPS module 104 at step 306. Then, a GPS reception sensitivity indicator 208 for indicating GPS reception sensitivity, instead of the mobile communication reception sensitivity indicator 202, is displayed on a screen 200 of the display 110 at step 308 as illustrated in FIG. 2B. In step 310, it is determined whether the GPS mode is terminated or not. Therefore, when the user selects the GPS mode at step 304, the user is able to check a GPS reception status by viewing the GPS reception sensitivity indicator 208 displayed on the screen 200 of the display 110 at steps 306 and 308. Thereafter, if the GPS mode is terminated at step 310, the MPU 100 returns to step 300.

However, if the Bluetooth mode is enabled by a user at step 304, the MPU 100 checks reception sensitivity of a Bluetooth signal determined by the Bluetooth module 106 at step 312. Then, a Bluetooth reception sensitivity indicator 214 for indicating Bluetooth reception sensitivity, instead of the mobile communication reception sensitivity indicator 202, is displayed on a screen 200 of the display 110 at step 314 as illustrated in FIG. 2C. In step 316, it is determined whether the Bluetooth mode is terminated or not at step 316. Therefore, when the user selects the Bluetooth mode at step 304, the user is able to check a Bluetooth reception status by viewing the Bluetooth reception sensitivity indicator 214 displayed on the screen 200 of the display 110 at steps 312 and 314. Thereafter, if the Bluetooth mode is terminated at step 316, the MPU 100 returns to step 300.

As described above, reception sensitivity of a communication function desired by a user is displayed on a display screen during either the GPS mode or the Bluetooth mode, so that the user is able to visibly check the reception status of each communication function.

While, it is necessary for a multi-functional mobile terminal to display reception sensitivity of each communication function on its own display screen when an operation mode of an arbitrary communication function is selected by the user as described above, it is preferable for the user to check a reception status of a communication function prior to selecting the operation mode of the communication function.

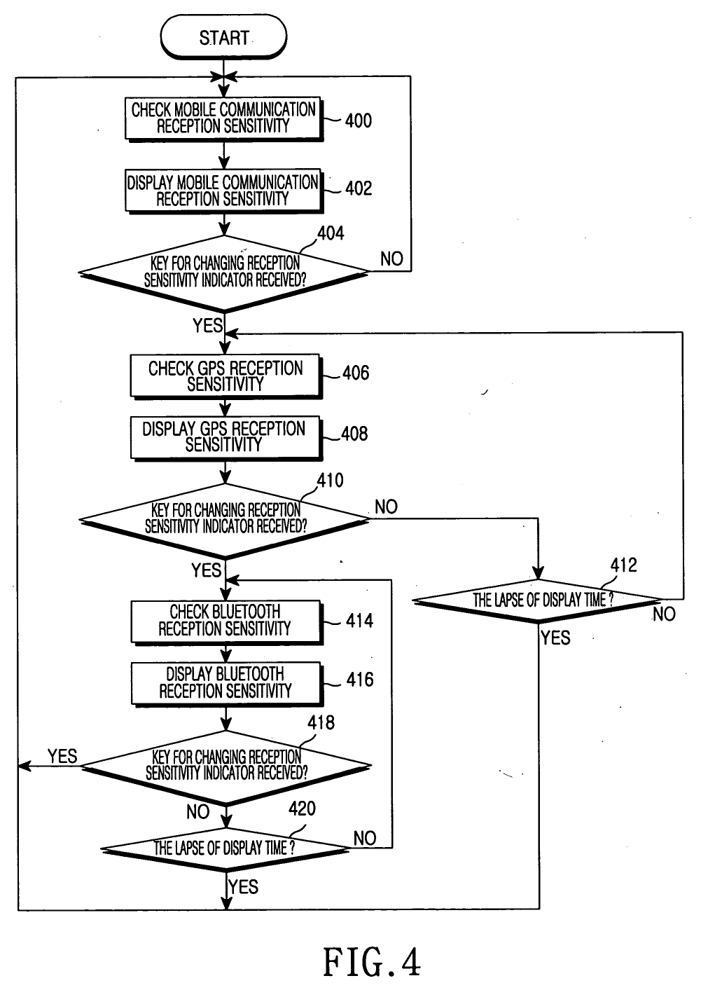

FIG. 4 is a flow chart illustrating a procedure for indicating reception sensitivity when a user wants to change a reception sensitivity indicator according to another preferred embodiment of the present invention. FIG. 4 denotes a plurality of steps 400˜420 serving as processes of the MPU 100. With reference to FIG. 4, the MPU 100 checks reception sensitivity of a signal received from a mobile telecommunication network using the mobile communication module 102 at step 400, displays the mobile communication reception sensitivity indicator 202 for displaying a mobile communication reception sensitivity on a display screen 200 of the display 110 at step 402 as shown in FIG. 2a, and determines at step 404 whether a prescribed key for changing a current reception sensitivity indicator to one of other reception sensitivity indicators enters the multi-functional mobile terminal. In this case, the prescribed key for changing the current reception sensitivity indicator to another is selected by the user who wants to vary reception sensitivity of a communication function currently displayed on the display screen 200 of the display 110, and is defined as a menu selection signal or a specific function key signal received from the key entry unit 108.

As stated above, when the user enters the key for changing the current reception sensitivity indicator to another on a key entry unit 108 at step 404 while the mobile communication reception sensitivity indicator 202 is displayed on the screen 200 of the display 110, the MPU 100 executes steps 406, 408, 410 and 412. The MPU 100 checks reception sensitivity of a GPS signal determined by the GPS module 104 at step 406, displays the GPS reception sensitivity indicator 208 for indicating GPS reception sensitivity, instead of the mobile communication reception sensitivity indicator 202, on the display screen 200 as shown in FIG. 2b at step 408, and then determines at step 410 whether the key for changing the current reception sensitivity indicator to another is selected by the user. If the key for changing the current reception sensitivity indicator has not been selected in step 410, then the MPU determines if a prescribed display time has elapsed in step 412. If the prescribed display time has elapsed, the MPU 100 returns to step 400. In this case, the display time is prescribed to return to an initial reception sensitivity display state as shown in FIG. 2A displaying the mobile communication reception sensitivity indicator 202, when there is no key signal for changing such a reception sensitivity indicator during the prescribed display time after changing the current reception sensitivity indicator to another. In addition, after changing the reception sensitivity indicator to a new one, this new reception sensitivity indication state may be maintained until the key for changing the reception sensitivity indicator is selected again. However, considering that a basic function of a multi-functional mobile terminal is a mobile communication function, it is preferable for the multi-functional mobile terminal to return to an initial reception sensitivity indication state.

As described above, if the key for changing the reception sensitivity indicator is selected by a user at step 410 before the lapse of a prescribed display time on condition that the GPS reception sensitivity indicator 208 is displayed on a display screen 200 of the display 110, the MPU 100 checks reception sensitivity of a Bluetooth signal determined by the Bluetooth module 106 at step 414, a Bluetooth reception sensitivity indicator 214 for indicating Bluetooth reception sensitivity, instead of the mobile communication reception sensitivity indicator 202, is displayed on a screen 200 of the display 110 at step 416 as shown in FIG. 2C, and it is determined at step 418 whether the key for changing the reception sensitivity indicator has been pushed. If the key for changing the current reception sensitivity indicator has not been selected in step 418, then the MPU determines if the prescribed display time has elapsed in step 420. In this case, if the prescribed display time has elapsed at step 420 or the key for changing the receptions sensitivity indicator has been pushed at step 418 before the lapse of the prescribed display time, the MPU 100 returns to step 400.

Therefore, if the key for changing the reception sensitivity indicator is pushed while the mobile communication reception sensitivity indicator is displayed as illustrated in FIG. 2A, a display screen mode is changed to another mode where a GPS reception sensitivity indicator is displayed as illustrated in FIG. 2B. When the key for changing the reception sensitivity indicator is pushed again, the display screen mode is changed to another mode where a Bluetooth reception sensitivity indicator is displayed as illustrated in FIG. 2C. If the key for changing the reception sensitivity indicator is pushed once again, the display screen mode is changed to yet other mode in which the mobile communication reception sensitivity indicator is displayed as illustrated in FIG. 2A. When a user does not stroke the key for changing the reception sensitivity indicator until the prescribed display time has elapsed on a display screen mode as illustrated in FIG. 2B or FIG. 2C, the mobile communication reception sensitivity indicator is displayed as illustrated in FIG. 2A.

As is apparent from the above description, in accordance with the present invention, provided that the user enters the key for changing the reception sensitivity indicator on the key entry unit 108, the user can easily check a reception status of a corresponding communication function without selecting an operation mode of the communication function. In this manner, a reception sensitivity indicator of such a communication function corresponding to an operation mode selected by the user is displayed, or reception sensitivity indicators are sequentially displayed according to a user's request signal for changing the reception sensitivity indicator, such that the user can easily check a reception status of each communication function. As a result, the present invention prevents the user from attempting to execute his or her desired communication function when a multi-functional mobile terminal is located in a non-communication area wherein the arbitrary communication function is disabled, thereby preventing unnecessary loss of time and unnecessary charges to the user.

In addition, a GPS search function of the GPS module 104 is executed when the MPU 100 activates a necessary module after a GPS mode has been enabled or the key for changing the reception sensitivity indicator has been pushed, and an RSSI check function of the Bluetooth module 106 is executed when the MPU 100 activates a necessary module after a Bluetooth mode has been enabled or the key for changing the reception sensitivity indicator has been pushed. However, in order to quickly display the GPS reception sensitivity indicator or a Bluetooth reception sensitivity indicator on the display screen, it is preferable for the GPS module to periodically execute a GPS search function in an idle mode, and also preferable for the Bluetooth module 106 to periodically execute an RSSI check function of a Bluetooth signal in the idle mode.

Particularly, although a multi-functional mobile terminal, having a GPS reception function and a Bluetooth communication function besides a general mobile communication function, is adapted to the present invention for the convenience of description and better understanding of the present invention, the present invention is also applicable to other multi-functional mobile terminals with either a GPS reception function or a Bluetooth communication function or any other communication functions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for displaying reception sensitivity on a display screen of a multi-functional mobile terminal with at least two communication functions, comprising the steps of:
a) checking a reception sensitivity of a reception signal for a prescribed communication function among the communication functions, and displaying a reception sensitivity indicator for indicating the reception sensitivity of the prescribed communication function on the display screen; and
b) if an operation mode of a communication function other than the prescribed communication function is enabled, checking reception sensitivity of a reception signal for the communication function corresponding to the enabled operation mode, and displaying a reception sensitivity indicator for indicating the reception sensitivity of the communication function corresponding to the enabled operation mode on the display screen.

2. The method as set forth in claim 1, further comprising the step of:
if the enabled operation mode is terminated, returning to the step (a) of displaying the reception sensitivity indicator of the prescribed communication function.

3. A method for displaying reception sensitivity on a display screen of a multi-functional mobile terminal having a mobile communication function for establishing mobile communication over a mobile telecommunication network and a GPS (Global Positioning System) reception function for receiving a GPS signal from a GPS satellite, comprising the steps of:
a) checking a reception sensitivity of a signal received from the mobile telecommunication network, and displaying a mobile communication reception sensitivity indicator for indicating a mobile communication reception sensitivity on the display screen; and
b) if a GPS mode is enabled, checking a reception sensitivity of the GPS signal, and displaying a GPS reception sensitivity indicator for indicating the GPS reception sensitivity on the display screen.

4. The method as set forth in claim 3, wherein the multi-functional mobile terminal further having a Bluetooth communication function for executing Bluetooth communication, further comprises the steps of:
c) if a Bluetooth mode is enabled, checking a reception sensitivity of a reception signal for the Bluetooth communication, and displaying a Bluetooth reception sensitivity indicator for indicating the Bluetooth reception sensitivity on the display screen.

5. The method as set forth in claim 3, wherein the GPS reception sensitivity indicator displays a reception sensitivity level corresponding to a number of GPS satellites found by the GPS signal.

6. The method as set forth in claim 4, further comprising the steps of:
returning to the step (a) of displaying the mobile communication reception sensitivity indicator after the GPS mode has been terminated; and
returning to the step (a) of displaying the mobile communication reception sensitivity indicator after the Bluetooth mode has been terminated.

7. A method for displaying reception sensitivity on a display screen of a multi-functional mobile terminal with at least two communication functions, comprising the steps of:
a) checking a reception sensitivity of a reception signal for a prescribed communication function among the communication functions, and displaying a reception sensitivity indicator for indicating the reception sensitivity of the prescribed communication function on the display screen; and
b) upon receiving a user request to change the reception sensitivity indicator, checking a reception sensitivity of a reception signal for a communication function other than the prescribed communication function among the communication functions, and displaying a reception sensitivity indicator for indicating the reception sensitivity of the other communication function on the display screen.

8. The method as set forth in claim 7, further comprising the step of:
returning to the step (a) of displaying the reception sensitivity indicator of the prescribed communication function when a predetermined time has elapsed after the reception sensitivity indicator of the other communication function has been displayed.

9. The method as set forth in claim 7, further comprising the step of:
if a user request to change the reception sensitivity indicator of the other communication function while displaying the reception sensitivity indicator of the other communication function, returning to the step (a) of displaying the reception sensitivity indicator of the prescribed communication function.

10. A method for displaying reception sensitivity on a display screen of a multi-functional mobile terminal having a mobile communication function for establishing mobile communication over a mobile telecommunication network and a GPS (Global Positioning System) reception function for receiving a GPS signal from at least one GPS satellite, comprising the steps of:
a) checking a reception sensitivity of a signal received from the mobile telecommunication network, and displaying a mobile communication reception sensitivity indicator for indicating the mobile communication reception sensitivity on the display screen; and
b) upon receiving a user request to change the reception sensitivity indicator while displaying the mobile communication reception sensitivity indicator, checking reception sensitivity of the GPS signal, and displaying a GPS a reception sensitivity indicator for indicating the GPS reception sensitivity on the display screen.

11. The method as set forth in claim 10, wherein the multi-functional mobile terminal further having a Bluetooth communication function for executing Bluetooth communication, said method further comprising the steps of:
c) upon receiving a user request to change the reception sensitivity indicator while displaying the GPS reception sensitivity indicator, checking a reception sensitivity of a reception signal for the Bluetooth communication, and displaying a Bluetooth reception sensitivity indicator for indicating the Bluetooth reception sensitivity on the display screen.

12. The method as set forth in claim 10, wherein the GPS reception sensitivity indicator displays a reception sensitivity level corresponding to a number of GPS satellites found by the GPS signal.

13. The method as set forth in claim 11, further comprising the step of:
returning to the step (a) of displaying the mobile communication reception sensitivity indicator when a prescribed time has elapsed after the Bluetooth reception sensitivity indicator has been displayed.

14. The method as set forth in claim 10, further comprising the step of:
returning to the step (a) of displaying the mobile communication reception sensitivity indicator when a prescribed time has elapsed after the GPS reception sensitivity indicator has been displayed.

15. The method as set forth in claim 11, further comprising the step of
upon receiving a user request to change the reception sensitivity indicator while displaying the Bluetooth reception sensitivity indicator, returning to the step (a) of displaying the mobile communication reception sensitivity indicator.
